(19) United States
(12) Patent Application Publication
(10) Pub. No.: US 2024/0149240 A1
(43) Pub. Date: May 9, 2024

(54) Sulfuric acid production with mineral carbon sequestration

(71) Applicant: The Regents of the University of California, Oakland, CA (US)

(72) Inventor: Laura Nielsen Lammers, Berkeley, CA (US)

(73) Assignee: The Regents of the University of California, Oakland, CA (US)

(21) Appl. No.: 18/403,666

(22) Filed: Jan. 3, 2024

Related U.S. Application Data
(63) Continuation of application No. PCT/US22/39829, filed on Aug. 9, 2022.
(60) Provisional application No. 63/285,079, filed on Dec. 1, 2021.
(60) Provisional application No. 63/231,365, filed on Aug. 10, 2021.

(51) Int. Cl. B01J 19/24; B01D 53/32; B01D 53/62; B01J 10/00; C01F 11/18; C25B 1/20; C25B 1/22; C25B 9/19; C25B 9/70; C25B 15/08

(52) U.S. Cl. CPC B01J 19/24; B01D 53/326; B01D 53/62; B01J 10/00; C01F 11/181; C25B 1/20; C25B 1/22; C25B 9/19; C25B 9/70; C25B 15/081; C25B 15/087; B01D 2251/404; B01D 2251/604; B01D 2251/608; B01D 2251/61; B01D 2257/504; B01D 2258/06

(57) ABSTRACT

A geomimetic process of sulfate replacement by mineralized carbonate, either in situ or ex situ, is used for mineral carbon sequestration and critical element recovery.

### CROSS-REFERENCE TO RELATED APPLICATIONS

This application is a continuation of PCT/US22/39829, filed: Aug. 9, 2022, which claims priority to U.S. Ser. No. 63/285,079, filed Dec. 1, 2021, and U.S. Ser. No. 63/231,365, filed Aug. 10, 2021; the disclosures of which applications are herein incorporated by reference.

### INTRODUCTION

Anthropogenic release of carbon dioxide to the atmosphere is causing global warming and climate change, and the extreme weather effects of warming are already being keenly felt. Globally, anthropogenic CO₂ emissions exceed 40 Gt/year, and affordable solutions to permanently sequester carbon are actively being sought to prevent further catastrophic environmental damage (Mac Dowell et al., 2017; Sullivan et al., 2021). Direct air capture of CO₂ with durable storage (DACS) is needed to enable the drawdown of atmospheric CO₂ concentrations to pre-industrial levels (IPCC, 2018). Typical direct air capture technologies require several GJ of energy input to sequester one metric ton of CO₂ without any useful byproducts other than supercritical CO₂ (Osman et al., 2020), so the high cost of carbon capture currently limits widespread implementation of this technology.

To conceive of sequestration technologies capable of matching the vast scales of global CO₂ emissions, scientists have turned to natural systems and processes for inspiration. Formation of carbonate minerals represents a safe, stable, and permanent way to remove and sequester carbon dioxide (cf. Lal, 2008), but mineral carbonation (MC) requires both a source of calcium and a source of alkalinity:

Ca²⁺+2OH⁻+CO₂(g)→CaCO₃(s). (reaction 1)

Over geologic timescales, the weathering of calcium-bearing silicate rocks at Earth's surface supplies the critical ingredients for MC to regulate the global atmospheric CO₂ concentration (Blättler and Higgins, 2017). However, these natural weathering reactions are not sufficiently fast to drawdown excess anthropogenic CO₂ emissions. Other examples of large-scale mineral carbonation process have been identified in the rock record associated with calcium sulfate mineral replacement reactions which have generated massive calcium carbonate limestone deposits (cf. Wigley, 1973):

CaSO₄·2H₂O(gypsum)+2OH⁻+CO₂(g)→CaCO₃(s)+SO₄²⁻(aq)+3H₂O(l). (reaction 2)

Formation of calcium carbonate minerals from gypsum (CaSO₄·2H₂O) has been suggested for permanent mineral carbon sequestration (Azdarpour et al., 2014; Mattila et al., 2015; Ruiz-Agudo et al., 2017; Rahmani et al., 2018; Yu et al., 2019), as the replacement of gypsum by calcium carbonate can proceed rapidly to completion (Fernandez-Diaz et al., 2009; Ruiz-Agudo et al., 2015; Yu et al., 2019). Gypsum feedstocks are readily available in natural evaporite deposits and as manmade byproducts of industrial phosphoric acid production. In the United States, natural gypsum reserves are estimated to be on the order of 700 Mt, and gypsum is actively mined in several states including Nevada (Crangle, 2020). The global fertilizer industry produces 100-280 Mt phosphogypsum (PG) powder per year as byproduct of sulfuric acid reaction with rock phosphorus (cf. Tayibi et al., 2009).

Both evaporite and PG-derived calcium sulfate minerals are ideal targets for conversion to calcium carbonates for permanent, gigaton-scale DACS. However, the lack of a suitably large and economical source of alkalinity has prevented large-scale mineral carbonation of gypsum. Gypsum dissolution supplies calcium to solution, but the creation of a carbonate mineral product still requires an alkalinity source, with two moles of alkalinity consumed per mol of carbon dioxide permanently sequestered as calcium carbonate (reaction 2). Electrolysis methods have been developed for industrial acid and base production (Paidar et al., 2016; Talabi et al., 2017), but these have historically consumed too much energy to be cost-competitive with conventional methods. In a typical membrane-separated electrochemical cell, fast migration of H⁺ or OH⁻ across the membrane relative to other cations and anions in solution significantly hampers the process efficiency.

Sulfuric acid is the most-produced inorganic chemical globally (>200 Mt/yr; King & Moats, 2013) for use in phosphate fertilizer production and other industries and is mainly produced through a chemical process involving oxidation of fossil fuel-derived elemental sulfur.

Calcium sulfate minerals can also supply a significant source of sulfate anion (SO₄²⁻) (reaction 1), and this sulfate can be used to produce sulfuric acid (H₂SO₄). Processes for electrolytic sulfuric acid production with carbon dioxide sequestration and portlandite (Ca(OH)₂) cement material production have been developed previously (Paleologou et al., 1997; Cardenas-Escudero et al., 2011; U.S. Pat. Nos. 8,227,127; 9,493,881; Monat et al., 2020). Monat et al. (2020) demonstrated a maximum production efficiency equivalent to 0.38 kWh/mol H₂SO₄ from gypsum using two-step bipolar membrane electrodialysis. However, this process requires the addition of concentrated sodium sulfate, and the process is too inefficient to be cost-competitive with traditional sulfuric acid production methods.

Relevant literature includes: U.S. Pat. Nos. 9,493,881, 8,691,175, 8,227,127, CN102899679A, CN102978653A and CN106757119B.

### SUMMARY

Aspects of the invention provide a geomimetic process of calcium or magnesium sulfate replacement by calcium or magnesium carbonate, either in situ or ex situ, e.g., for one or more of mineral carbon sequestration, critical element recovery, and sulfuric acid recycling. Embodiments of the invention provide for improvements over current processes. Embodiments of the invention improve upon past processes by maintaining a lower concentration of OH⁻ in the catholyte solution, reducing Faradaic losses while protecting the AEMs from degradation in concentrated base (Vega et al., 2010). Embodiments of the invention achieve more efficient sulfuric acid production, including an energy intensity of acid production less than 0.2 kWh/mol H₂SO₄.

In an aspect the invention provides a system that couples sulfuric acid production to mineral carbon sequestration, the system comprising:
an electrolyzer stack of one or more electrochemical cells comprising:
   an anode within an anode chamber containing an anolyte,
   a cathode within a cathode chamber containing a catholyte, and
   an anion exchange membrane separating the anode and cathode chambers;
a mineralized carbonate production reactor configured to receive a hydroxide solution from the cathode chamber, to generate mineralized carbonate from a sulfate feedstock and CO₂, and to return a portion of the reactor solution to the catholyte; and
a sulfuric acid recovery module configured to receive sulfuric acid from the anode chamber.

In embodiments:
the system is configured as a continuous flow system;
the mineralized carbonate production reactor is operably connected to a source of sulfate;
the source of sulfate may be any convenient sulfate, and in some instances is a solid sulfate, e.g., a solid mineral sulfate, such as calcium or magnesium sulfate, where in some instances the source of sulfate comprises solid calcium sulfate;
the mineralized carbonate production reactor is operably connected to a source of CO₂;
the source of CO₂ comprises air or another source of CO₂, e.g., flue gas or other CO₂ comprising multi-gaseous stream, that is contacted to the hydroxide solution from the cathode chamber to produce aqueous carbonate solution;
the mineralized carbonate production reaction is configured to convert a source of sulfate, e.g., gypsum, to mineral carbonate, e.g., calcium carbonate, according to reaction 2:

CaSO₄·2H₂O(gypsum)+2OH⁻+CO₂(g)→CaCO₃(s)+SO₄²⁻(aq)+3H₂O(l);
the anion exchange membrane is configured so that sulfate anion crosses the anion exchange membrane to the anode chamber where sulfuric acid is generated;
the system is configured to maintain a relatively low concentration of base (OH⁻) in the catholyte relative to the concentration of acid (H⁺) in the anolyte, where in some instances the magnitude of the H⁺:OH⁻ ratio ranges from 5 to 100,000, such as 10 to 100 and including 2 to 200,000, where the relatively lower concentration of base is provided by flowing the catholyte through the cathode chamber, e.g., as a total stack flow rate ranging in some instances from 300 to 10,000 liters per minute (L/min) such as 500 to 1000 L/min for a 1 metric ton CO₂ mineralization per day system, e.g., by recirculating fluid from the reactor through the cathode chamber;
the system is configured to generate an acid concentration in the anolyte that is higher than the base concentration in the catholyte even though protons and hydroxides are produced at the same rate in the electrochemical cell where in some instances the magnitude of the acid to base concentration ratio ranges from 5 to 100,000, such as 10 to 100;
on the anode side of the system, water is recirculated at a constant rate through the anode chamber to allow for accumulation of sulfuric acid, e.g., at a total stack flow rate ranging in some instances from 15 to 100 L/min, such as 60 to 90 L/min and including 10 to 300 L/min for a 1 metric ton CO₂ mineralization per day system;
the system is configured for hydrometallurgical extraction or recovery using sulfuric acid obtained from the sulfuric acid recovery module;
the hydrometallurgical extraction or recovery comprises sulfuric acid leaching of lithium claystone;
the system is further configured to return the leachate post-lithium extraction to the mineralized carbonate production reactor to recycle the sulfate and produce mineralized carbonate therefrom;
the system is configured for phosphoric acid production with mineral carbon sequestration;
the system is configured for generation of phosphoric acid from rock phosphorus with mineralized carbonate, e.g., calcite, as the solid product as described by the formula:

Ca₅F(PO₄)₃(fluorapatite)+5CO₂(g)+5H₂O(l)→5CaCO₃(calcite)+3H₃PO₄+HF;
the system is configured to include cyclic steps of electrochemical production of sulfuric acid at the anode and a hydroxide aqueous solution, e.g., calcium hydroxide aqueous solution, at the cathode, wherein the hydroxide solution is reacted with carbon dioxide to produce solid carbonate, e.g., solid calcium carbonate;
the system is configured to include cyclic steps of electrochemical production of sulfuric acid at the anode and hydroxide aqueous solution, e.g., calcium hydroxide aqueous solution, at the cathode, wherein the hydroxide solution is reacted with carbon dioxide and divalent cation, e.g., calcium or magnesium ion, to produce a solid carbonate, e.g., solid calcium or magnesium carbonate, wherein the sulfuric acid anolyte is recovered, concentrated as desired, e.g., to >70% H₂SO₄, and in some instances reacted with rock phosphorus to produce phosphoric acid, calcium sulfate, and HF, wherein the product calcium sulfate is returned to the process to produce calcium carbonate and sulfate solution, wherein the sulfate solution is returned to the electrochemical cell along with water to continue the cycle;
the system is further configured to sequester carbon dioxide as mineralized carbonate, e.g., calcium carbonate, and produce sulfuric acid by reacting sulfate solids, e.g., calcium sulfate solids, with electrochemically produced hydroxide solution contacted with carbon dioxide directly from air or from a more concentrated source;
the system is further configured to include one or more of a sulfuric acid concentration step, a step to recover hydrogen or energy from produced hydrogen using a fuel cell, a phosphoric acid production step, and valuable co-product recovery steps;
the system is further configured to include a step for separation of valuable co-products that are incompatible with calcium carbonate, which will be released into solution during the conversion of calcium sulfate to calcium carbonate, wherein these co-products are separated from the sulfate solution stream prior to reintroduction of the sulfate solution to the electrochemical cell;
the valuable co-products include one or more of uranium, nickel, and other elements;
the system is further configured to be combined to recover valuable elements before and after calcium sulfate carbonation, with or without phosphoric acid production;
the source of sulfate comprises aqueous sulfate solutions containing calcium or magnesium and other dissolved salts;
the source of sulfate comprises mainly magnesium sulfate in a mixed leachate stream containing other salts including sodium and calcium sulfate.

In an aspect the invention provides a process for mineral carbonation with sulfuric acid production that sequesters CO₂ directly from air while efficiently producing sulfuric acid using sulfate wastes as well as other readily available materials. In embodiments, the process avoids the usual pitfalls of electrochemical acid-base production by maintaining a low concentration of OH⁻ in the catholyte solution, such that the ratio of sulfate (SO₄²⁻) to hydroxide (OH⁻) in the catholyte is greater than 10. This configuration ensures that the flux of sulfate ions across the anion exchange membrane (AEM) is greater than the flux of hydroxide ions, minimizing Faradaic losses and increasing energy efficiency. The precipitation of carbonate, hydroxide, and hydroxycarbonate minerals consumes alkalinity, so the concentration of produced sulfuric acid is greater than the concentration of hydroxide in the catholyte by a factor of 5 or greater. Suitable AEMs minimize voltage by allowing a sufficiently high sulfate flux, while limiting proton leakage, and are durable over the pH range 0-14. The process for calcium is summarized by the reaction,

CaSO₄·2H₂O(gypsum)+CO₂(g)→CaCO₃(calcite)+H₂SO₄(aq)+H₂+½O₂(g),
and is schematically illustrated in FIG. 1. The process enables direct air capture of carbon dioxide to permanently sequester the CO₂ as calcium carbonate, although gas mixtures containing more concentrated carbon dioxide can also be used, e.g., industrial exhaust gasses, power plant flue gasses, etc. While the process is described for gypsum and production of calcite, the invention is not so limited, any convenient sulfate source may be employed, such as solid sulfate sources, e.g., calcium sulfate, magnesium sulfate, etc. Any convenient mineralized carbonate may be produced, such as calcium carbonate, magnesium carbonate, etc. The co-product H₂(g) from hydrolysis can be collected, e.g., to recover electrical energy via a fuel cell or compressed for sale of green hydrogen. Below are reported the results of a series of experiments conducted to establish the proof of concept for sulfuric acid production with mineral carbon sequestration, and to quantify the electrical energy consumption of the process as a function of the electrochemical cell current. While the current applied to an electrolyzer in embodiments of the invention may vary, in some instances the applied current ranges from 60 to 400 mA/cm² such as 150 to 300 mA/cm². Industrial-scale implementation of the process is discussed in the context of two applications: Lithium extraction from claystone and phosphate fertilizer production, although the invention is not so limited.

In an aspect the invention provides methods, processes, compositions and systems for divalent cation, e.g., calcium or magnesium cation, sulfate carbonation for mineral carbon sequestration with sulfuric acid production and, in some instances critical resource extraction or green cement production.

In aspects, the source of sulfate, e.g., calcium or magnesium sulfate, supplied to the system is a solid waste product, such as phosphogypsum (CaSO₄·2H₂O with impurities) or solid hydrated magnesium sulfate (MgSO₄·nH₂O with impurities).

In aspects, the source of sulfate, e.g., calcium or magnesium sulfate, is an aqueous leachate stream containing calcium or magnesium sulfate (>0.1 M) in addition to other dissolved aqueous species.

In an aspect the invention provides a method to sequester carbon dioxide as mineral carbonate, e.g., calcium or magnesium carbonate, and produce sulfuric acid by reacting sulfate solids, e.g., calcium or magnesium sulfate solids, with electrochemically produced hydroxide solution contacted with carbon dioxide directly from air or from a more concentrated source, e.g., industrial exhaust gasses, power plant flue gasses, etc.

In an aspect the invention provides electrochemical production of sulfuric acid and solid calcium carbonate (as calcite, aragonite or vaterite) from solid calcium sulfate, and carbon dioxide, with applications to mineral carbon sequestration, industrial fertilizer production, and green cement production.

In an aspect the invention provides electrochemical production of sulfuric acid and solid magnesium carbonate (for example as magnesite, nesquehonite, or lansfordite) or solid magnesium hydroxycarbonate (for example as dypingite or hydromagnesite), from industrial or mining waste solids or solutions containing dissolved aqueous magnesium sulfate and carbon dioxide, with applications to mineral carbon sequestration, critical element extraction from magnesium silicate-bearing ores or mine tailings, and green cement production.

In an aspect the invention provides electrochemical production of sulfuric acid and solid magnesium hydroxide (as brucite) from industrial or mining waste solids or solutions containing dissolved aqueous magnesium sulfate, with applications to green cement production and critical element extraction from magnesium silicate-bearing ores or mine tailings.

In aspects the produced sulfuric acid is used to extract critical elements and carbon dioxide reactive elements (e.g. calcium and magnesium) from silicate rocks, and a neutralized sulfate leachate solution is used as the feed solution supplying waste sulfate to the precipitation reactor.

In aspects the invention provides electrochemical production of sulfuric acid and carbonate solids containing calcium or magnesium as the major cation with minor calcium, magnesium, iron, manganese, or other ions that form sparingly soluble carbonate minerals. These solids can precipitate as separate phases such as siderite (FeCO₃) or rhodochrosite (MnCO₃), or in solid solution with the major calcium or magnesium carbonate phase.

In an aspect the invention provides electrochemical production of sulfuric acid and calcium or magnesium carbonate from calcium or magnesium sulfate and carbon dioxide, with applications to mineral carbon sequestration and green cement production.

In an aspect the invention provides a method to sequester carbon dioxide as magnesium carbonate and produce sulfuric acid for reaction with magnesium silicate minerals by reacting magnesium sulfate leachate solution with electrochemically produced hydroxide solution contacted with carbon dioxide directly from air or from a more concentrated source, e.g., industrial exhaust gasses, power plant flue gasses, etc.

In aspects of the invention, additional sodium sulfate solution is supplied to the solution recirculating through the cathode chamber to maintain a sulfate to hydroxide ratio>10 in the catholyte solution.

In some aspects, additional sodium sulfate solution is supplied to the solution recirculating through the cathode chamber to maintain a sulfate to hydroxide ratio>10 in the catholyte solution, and the majority of the sodium sulfate is recycled through the system.

In some aspects, the method can use gases containing dilute carbon dioxide with concentrations less than 1% CO₂ (e.g. air) by contacting the catholyte solution with the gas to form solutions containing aqueous (bi)carbonate that are then supplied to a precipitation reactor for precipitation of carbonate minerals.

In some aspects, the method can use gases containing concentrated carbon dioxide by bubbling gas directly through the precipitation reactor solution using a disseminator or other suitable system to produce gas bubbles.

The method can include one or more of a sulfuric acid concentration step, a step to recover hydrogen or energy from produced hydrogen using a fuel cell, a phosphoric acid production step, and valuable co-product recovery steps.

In aspects, the sulfate associated with the precipitated magnesium or calcium is substantively recycled in the system to reduce the accumulation of sulfate wastes during mining and fertilizer production.

In an aspect the invention provides a process, method or system for mineral carbon dioxide sequestration and sulfuric acid production.

In some aspects the source of electricity for the process is a low-carbon energy source generated by solar, wind, hydroelectric, geothermal, hydrogen, nuclear, or fusion power plants that can optionally be purchased from the electrical grid.

In aspects the energy intensity of water electrolysis in the electrochemical cell is less than 0.4 kWh/mol H₂SO₄ and in the range between 0.1 to 0.4 kWh/mol H₂SO₄.

In embodiments the oxygen gas produced at the anode is off-gassed to the atmosphere, is collected to be compressed and sold, or is used as an oxidant in the sulfuric acid extraction process to avoid sulfate-reducing conditions.

In embodiments the produced carbonate, hydroxycarbonate, or hydroxide solids are used in the production of cement, concrete, chalk, or manufactured stone.

In other embodiments the produced carbonate, hydroxycarbonate, or hydroxide solids are used to neutralize acidity, for example to neutralize an acid leachate solution generated during a sulfuric acid extraction process. In these embodiments, concentrated carbon dioxide can be released by the reaction of carbonate containing solids with acid. The carbon dioxide can be re-captured for sequestration (e.g. geologic carbon sequestration) or used in the precipitation reactor as the carbon dioxide source.

In embodiments the invention provides a process for calcium sulfate (anhydrous, hemihydrate, or dihydrate) carbonation and production of sulfuric acid from liberated sulfate ions.

Accordingly the invention provides methods, processes, compositions and systems for mineral carbon sequestration and critical element recovery.

In an aspect the invention provides a continuous flow reactor system that couples sulfuric acid production to mineral carbon sequestration, the system comprising:

an electrochemical cell or stack of electrochemical cells comprising an anode within an anode chamber containing an anolyte, a cathode within a cathode chamber containing a catholyte, and an anion exchange membrane separating the anode and cathode chambers, and a mixed flow reactor coupled to the cathode chamber, wherein the mixed flow reactor is configured for converting a sulfate to a solid carbonate for example by reaction 2:

MSO₄(solid or aqueous)+2OH⁻+CO₂(g)→MCO₃(s)+SO₄²⁻(aq)+H₂O (where M=Ca or Mg),
wherein effluent from the mixed flow reactor is recirculated into the cathode chamber to supply sulfate anion and wherein alkalinity increases by a water reduction reaction on the cathode: H₂O+e−→OH−+½H₂(g),
wherein some embodiments separate carbonate solids from the mixed flow reactor effluent by passing the slurry through a filter,
wherein the sulfate anion crosses the anion exchange membrane to the anode chamber where sulfuric acid is generated,
wherein hydroxide solution produced in the cathode chamber is returned to the mixed flow reactor, where it reacts with CO₂ that is introduced by bubbling atmospheric air or a more concentrated source of CO₂ according to the reaction:

CaSO₄·2H₂O(gypsum)+CO₂(g)→CaCO₃(calcite)+H₂SO₄(aq)+H₂+½O₂(g),
wherein the effluent from the cathode chamber is returned into the mixed flow reactor to supply alkalinity for calcium carbonate precipitation, which lowers the solution pH as alkalinity is consumed by the reaction:

Ca²⁺+2OH⁻+CO₂(g)→CaCO₃(s),
wherein aqueous sulfuric acid is recirculated through the anode chamber to allow for accumulation of sulfuric acid, where protons and oxygen are generated by hydrolysis at the anode,
wherein sulfate ions migrate from the catholyte via the anion exchange membrane to balance charge, and sulfuric acid is recovered as the anolyte,
wherein the system maintains a relatively low concentration of base (OH⁻) in the catholyte relative to the concentration of acid (H⁺) in the anolyte by recirculating fluid from the reactor through the cathode chamber rather than using the same solution feeds into the cathode and anode chambers, such that although protons and hydroxides are produced at the same rate in the electrochemical cell, the system generates an acid concentration in the anolyte that is much higher than (by at least about 5 times to about 200,000 times) the base concentration in the catholyte, because the fluids are circulated separately, which (i) minimizes Faradaic losses by migration of OH⁻ across the anion exchange membrane and resulting loss reaction: OH−+H+→H₂O in the electrochemical cell and (ii) protects the anion exchange membrane from degradation in strong base.

In embodiments:
the electrochemical cell stack comprises a stack of cells containing an acid-resistant anode (e.g., consisting of titanium, platinized titanium, carbon, or other conductive support) with catalyst for water oxidation (e.g., platinum, iridium oxide, or other catalyst suitable for water oxidation) either deposited on the anode or directly on the membrane and a cathode (e.g., consisting of porous titanium, stainless steel, nickel or other material suitable for water reduction) separated by the membrane, connected to a source of electrical current such as a power supply or potentiostat;
on the anode side of the system, a neutral or acidic aqueous solution (pH<7) consisting of water, sulfuric acid solution, or aqueous salt solution is flowed or recirculated through the anode chamber to allow for the accumulation of sulfuric acid;
the system is further configured for hydrometallurgical extraction or recovery (FIG. 6);
the system is further configured for hydrometallurgical extraction or recovery (FIG. 6) by sulfuric acid leaching of lithium claystone or other magnesium or calcium silicate, with return of the leachate post-lithium extraction to the mixed flow reactor, recycling the sulfate and precipitating the calcium/magnesium sulfate as calcium/magnesium carbonate;
the system is further configured for phosphoric acid production with mineral carbon sequestration (FIG. 7);
the system is further configured for phosphoric acid production with mineral carbon sequestration (FIG. 7) by generation of phosphoric acid from rock phosphorus with calcite as the solid product instead of phosphogypsum, for example:

Ca₅F(PO₄)₃(fluorapatite)+5CO₂(g)+5H₂O(l)→5CaCO₃(calcite)+3H₃PO₄+HF;
the system is further configured to include cyclic steps of electrochemical production of sulfuric acid at the anode and calcium or magnesium hydroxide aqueous solution at the cathode, wherein the hydroxide solution is reacted with carbon dioxide in the presence of a divalent cation (e.g. Mg²⁺/Ca²⁺) to produce a mineral carbonate (e.g. magnesium (hydroxy)carbonate as magnesite, nesquehonite, lansfordite, dypingite, hydromagnesite or calcium carbonate as calcite, aragonite, or vaterite);
the system is further configured to include cyclic steps of electrochemical production of sulfuric acid at the anode and calcium hydroxide aqueous solution at the cathode, wherein the hydroxide solution is reacted with carbon dioxide to produce solid calcium carbonate, wherein the sulfuric acid anolyte is recovered, concentrated as necessary to >70% H₂SO₄ and reacted with rock phosphorus to produce phosphoric acid, calcium sulfate, and HF (as in reaction 2), wherein the product calcium sulfate is returned to the process to produce calcium carbonate (e.g., as calcite, aragonite, and/or vaterite) and sulfate solution, wherein the sulfate solution is returned to the electrochemical cell along with water to continue the cycle (FIG. 7;
the system is further configured to sequester carbon dioxide as MC, e.g., calcium carbonate, and produce sulfuric acid by reacting calcium sulfate solids, magnesium sulfate solids, or aqueous solutions containing dissolved calcium or magnesium sulfate, with electrochemically produced hydroxide solution contacted with carbon dioxide directly from air or from a more concentrated source;
the system is further configured to include a sulfuric acid concentration step, a step to recover hydrogen or energy from produced hydrogen using a fuel cell, a phosphoric acid production step, and valuable co-product recovery steps;
the system is further configured to include a step for separation of valuable co-products that are incompatible with calcium carbonate such as uranium, nickel, and other elements, which will be released into solution during the conversion of calcium sulfate to calcium carbonate, wherein these co-products are separated from the sulfate solution stream prior to reintroduction of the sulfate solution to the electrochemical cell; and/or
the system is further configured to be combined to recover valuable elements before and after calcium sulfate carbonation, with or without phosphoric acid production.

In an aspect the invention provides a method for sulfuric acid production with mineral carbon sequestration, the method comprising deploying a continuous flow reactor system described herein to couple sulfuric acid production to mineral carbon sequestration.

In an aspect the invention provides a geomimetic process of calcium sulfate replacement by calcium carbonate for mineral carbon sequestration, the method comprising deploying a continuous flow reactor system to couple sulfuric acid production to mineral carbon sequestration.

The invention encompasses all combinations of the particular embodiments recited herein, as if each combination had been laboriously recited.

### BRIEF DESCRIPTION OF THE DRAWINGS

FIG. 1 is a schematic diagram of the steps of a process for mineral carbon sequestration by carbonation of gypsum with production of sulfuric acid.

FIGS. 2A-C depict the time evolution of pH at each process sampling point shown in FIG. 1 for experiments run at three different currents respectively: 0.01 A, 0.02 A, and 0.05 A.

FIG. 3 shows the rate of carbonation as a function of the rate of OH⁻ addition to the mixed flow reactor for the experiment run at 0.01 A current. The strong linear correlation between the calculated carbonation rate (R_{carb}) and the hydroxide addition rate is indicative of a condition that is rate-limited by base production at the cathode.

FIGS. 4A-B illustrate the process efficiency as a function of current in terms of the acid production rate in moles H₂SO₄ produced per minute (A) and the power consumption per mole of H₂SO₄ produced (B) in solutions of sodium, calcium, and magnesium sulfate and mixtures thereof.

FIGS. 5A-B shows the results of the batch mode electrochemical efficiency test (A) illustrating high Faradaic efficiency of the electrochemical cell in 1M Na₂SO₄ solution. Experimental results (B) showing the evolution of Faradaic efficiency for the process illustrated in FIG. 1 as a function of the ratio of measured aqueous SO₄ concentration to aqueous OH⁻ concentration, demonstrating that maintaining low pH (low concentration of OH⁻) in the cathode chamber maximizes the process efficiency.

FIG. 6 is a flow chart of the steps of an embodiment of the method for mineral carbon sequestration by carbonation of gypsum with production of sulfuric acid, use of the sulfuric acid for leaching of lithium claystone for lithium recovery, return of the lithium-free leachate for recycling of both water and sulfate.

FIG. 7 is a flow chart of the steps of a method for phosphoric acid production with mineral carbon sequestration using sulfate autocatalytically to produce intermediate gypsum, which is subsequently reacted to form mineral calcium carbonate.

FIG. 8 is a flow chart of the steps of a method for mineral carbon sequestration by carbonation of gypsum with production of sulfuric acid.

FIG. 9 is a flow chart of the steps of a method for phosphoric acid production with mineral carbon sequestration using sulfate autocatalytically to produce intermediate gypsum, which is subsequently reacted to form mineral calcium carbonate.

FIG. 10 is a flow chart of the steps of an embodiment of the method for mineral carbon sequestration by carbonation of gypsum with production of sulfuric acid, with additional production of valuable co-products that are incompatible with calcium carbonate and therefore released into the sulfate solution during calcium sulfate conversion to calcium carbonate.

FIG. 11 is a flow chart of the steps of an embodiment of the method for mineral carbon sequestration by carbonation of gypsum with production of sulfuric acid, with additional production of valuable co-products that are compatible with calcium carbonate. Additional process steps implement a sodium hydroxide leach of the calcium sulfate with co-product recovery prior to conversion of the gypsum to calcium carbonate.

### DESCRIPTION OF PARTICULAR EMBODIMENTS OF THE INVENTION

Unless contraindicated or noted otherwise, in these descriptions and throughout this specification, the terms “a” and “an” mean one or more, the term “or” means and/or. It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein, including citations therein, are hereby incorporated by reference in their entirety for all purposes.

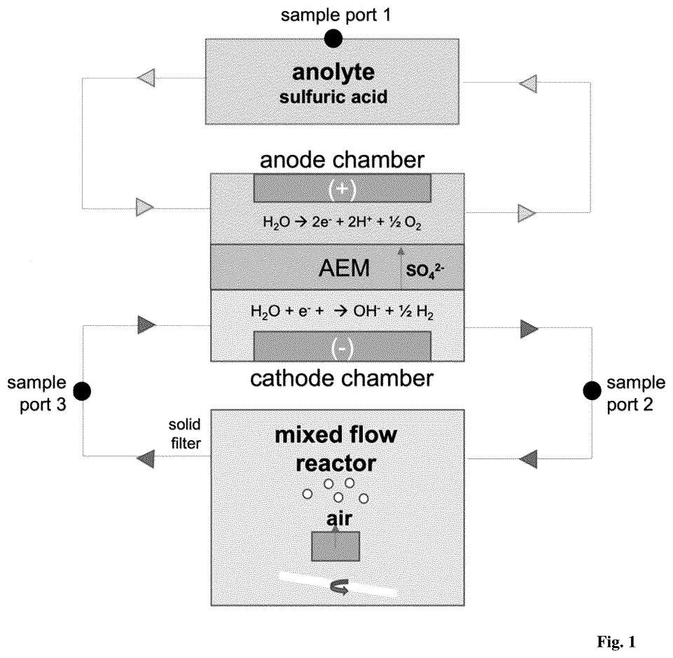

Aspects of the invention include a process, such as a continuous flow process, for sulfuric acid production that permanently sequesters CO₂, such as atmospheric air-derived CO₂, as mineral carbonate, e.g., through the replacement of calcium or magnesium sulfate by calcium or magnesium carbonate. FIG. 1 is a flow chart illustrating an embodiment of the invention wherein solid calcium sulfate is introduced to a mineral precipitation reactor where it is converted to calcium carbonate by reaction with carbon dioxide from air and alkalinity produced in a two-chamber water electrolyzer. Effluent from the precipitation reactor is recirculated through the cathode chamber of the water electrolyzer, where sulfate liberated in reaction 1 crosses an anion exchange membrane to gradually accumulate sulfuric acid in a recirculating anolyte solution. During operation of the calcium-containing system, sulfuric acid and calcium carbonate are produced by reacting a calcium sulfate source with electrochemically produced hydroxide contacted with carbon dioxide derived from atmospheric air, although more concentrated sources of carbon dioxide can also be used. While the illustrated embodiment is shown in the context of gypsum and the production of calcite, the invention is not so limited, as other sources of sulfate may be employed to generate other types of mineralized carbonate, e.g., as described above.

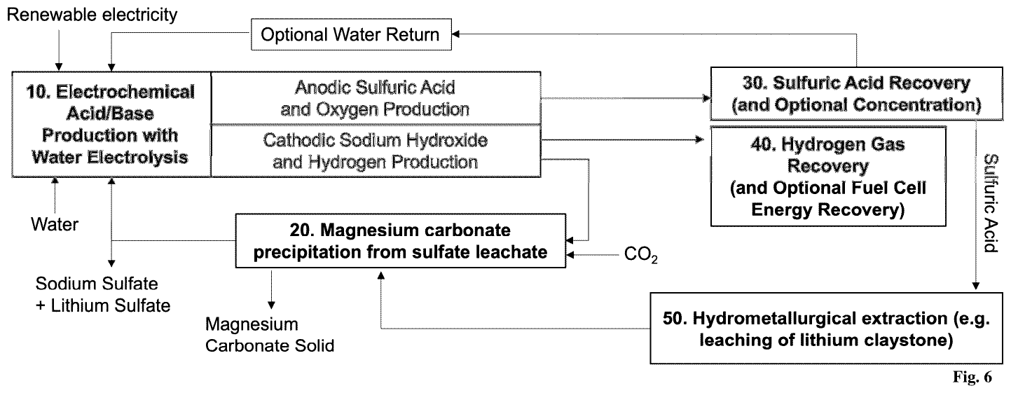

An embodiment of the invention integrates the process illustrated in FIG. 1 into hydrometallurgical extractions of magnesium silicate minerals with sulfuric acid to produce magnesium carbonate or hydroxycarbonate solids, green hydrogen, and recycled sulfuric acid. An example of this embodiment is illustrated as a simplified flow diagram in FIG. 6 for lithium extraction from claystone. Step 10 illustrates sulfuric acid production, recirculation, and accumulation in the anode chamber along with base production in the cathode chamber of an electrochemical cell or stack of electrochemical cells. Alkaline solutions produced in the cathode chamber are flowed to the mineral production reactor in step 20 where magnesium sulfate is reacted with CO₂ from air or another concentrated source and alkalinity to produce solid magnesium carbonate products. Sulfuric acid is recovered and optionally concentrated in step 30, and produced green hydrogen gas is recovered and optionally either concentrated or used in a fuel cell to generate electricity in step 40. Magnesium sulfate solution is introduced to the mineral production reactor from the extractive process shown in Step 50. The extractive process in various embodiments can involve extractions of critical elements such as lithium from magnesium silicate materials using sulfuric acid of different concentrations ranging from about 1 wt. % to 70 or more wt. %. Acidity is neutralized in step 50 producing a sulfate waste stream that is introduced to the mineral precipitation reactor in step 20, which allows for recycling of the sulfuric acid used in the extractive process.

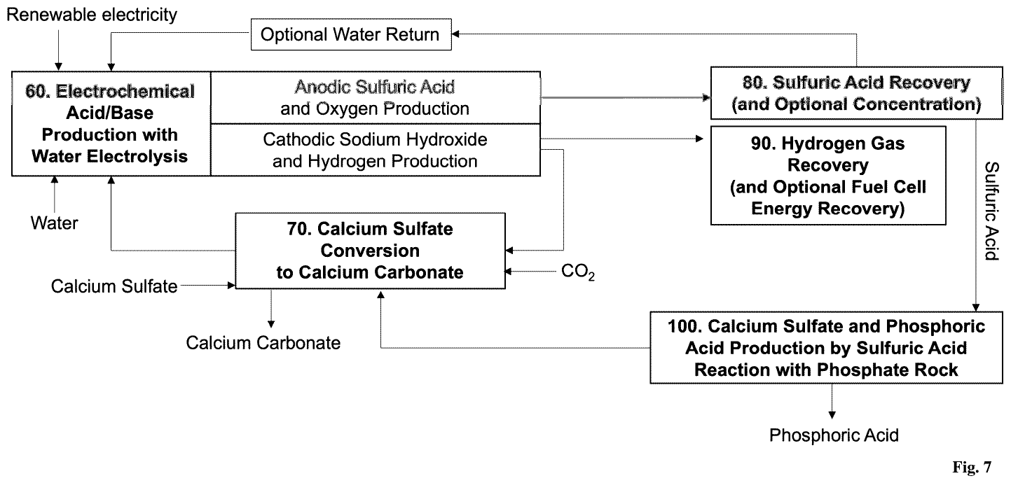

In other embodiments, the method can be integrated into phosphate fertilizer production to generate calcium carbonate byproducts instead of calcium sulfate, substantially mitigating an important environmental impact of agricultural fertilizer production, illustrated in FIG. 7. In this embodiment, sulfuric acid and alkaline solution are produced by water electrolysis in step 60 in an electrochemical cell or stack of electrochemical cells. Sulfuric acid is produced and optionally recirculated in the anode chamber along, and a hydroxide solution is produced from a sulfate feed solution in the cathode chamber, as shown in FIG. 1. Alkaline solutions produced in the cathode chamber are flowed to the mineral production reactor in step 70 where calcium sulfate is reacted with CO₂ from air or another concentrated source and alkalinity to produce solid calcium carbonate products. Sulfuric acid is recovered and optionally concentrated in step 80, and produced green hydrogen gas is recovered and optionally either concentrated or used in a fuel cell to generate electricity in step 90. Calcium sulfate is introduced to the mineral production reactor from phosphoric acid production process shown in Step 100. The production of phosphoric acid is accomplished by reacting produced sulfuric acid with phosphate rock, which produces solid calcium sulfate (as phosphogypsum). The waste phosphogypsum produced in step 100 is introduced to the mineral precipitation reactor in step 70, which allows for recycling of the sulfuric acid in phosphoric acid production and importantly avoids the accumulation of phosphogypsum waste.

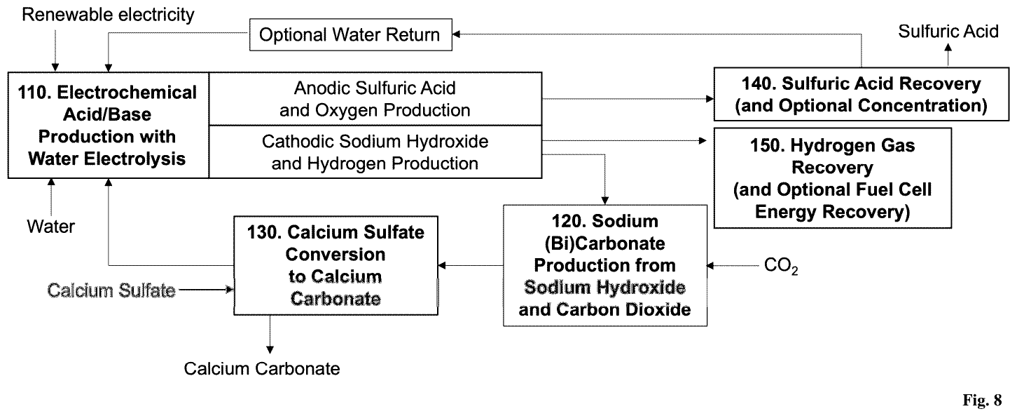

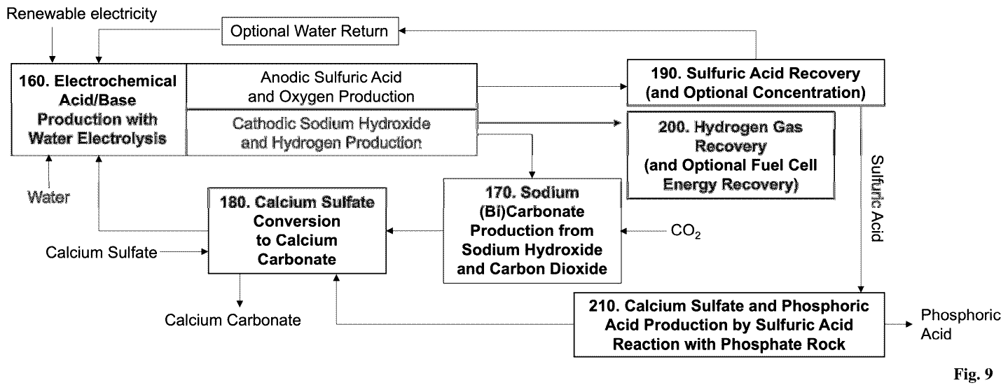

In an embodiment illustrated in FIG. 8, carbon dioxide is introduced to the process prior to the mixed flow reactor by a separate gas contactor apparatus in step 120, in a process otherwise identical to the illustration in FIG. 1. There is a large energy cost associated with bubbling gas through water as required when the gas contacting and precipitation reaction steps are combined into one step (e.g. steps 20 and 70). For example, for a gas disseminator producing 3 μm air bubbles, the pressure drop is estimated to be 13 PSI based on the Young-Laplace equation. An air contactor operated at a very small pressure drop reduces the energy required to remove carbon dioxide from low concentration sources such as air. The addition of a separate gas contactor step as illustrated in FIG. 8 applies to all other embodiments of the invention, and an example of the overall process for phosphoric acid production using a separate gas contactor apparatus is illustrated in FIG. 9.

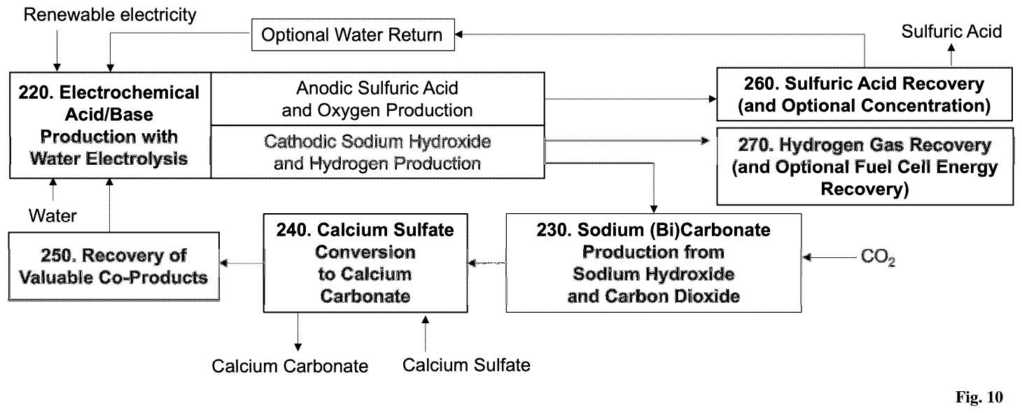

In certain embodiments, the method illustrated in FIGS. 7 and 9 can further include a step for separation of valuable elements released into solution during the conversion of calcium sulfate to calcium carbonate as shown in FIG. 10. In step 240, the conversion of phosphogypsum to calcium carbonate releases elements that are compatible in sulfate minerals but incompatible in carbonate minerals. These co-products may be separated from the sulfate solution stream as in step 250 prior to reintroduction of the sulfate solution to the electrochemical cell or stack of cells.

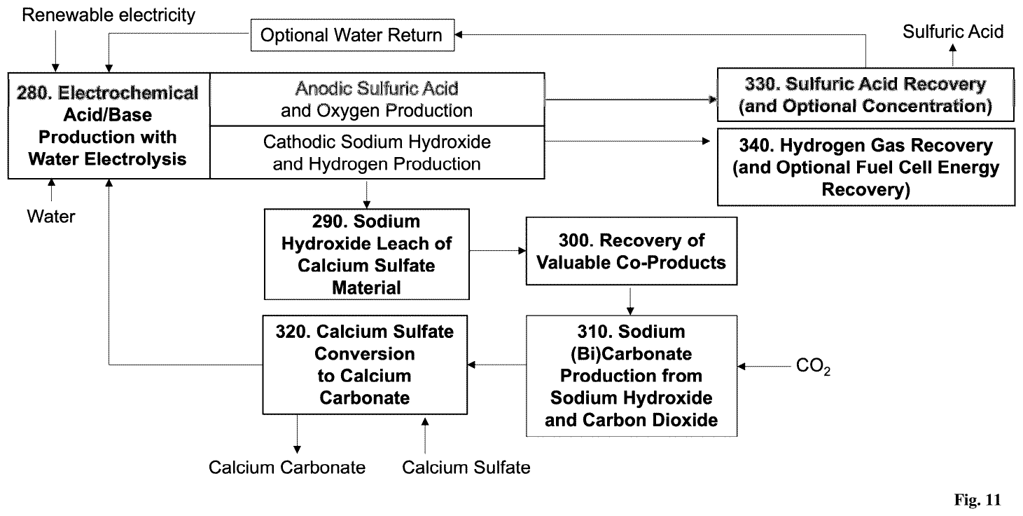

To selectively recover elements that are compatible with the carbonate mineral precipitates, elements can be recovered prior to the mineral production reactor as illustrated in FIG. 11. Step 290 consists of a basic leach of the material, followed by step 300 to recover the carbonate-compatible elements of interest. The extracted leachate can then be introduced to the contactor in step 310 of the embodiment, followed by sulfate carbonation in step 320.

In other embodiments, multiple embodiments can be combined to recover valuable elements before and after calcium sulfate carbonation, with or without phosphoric acid production.

### Examples

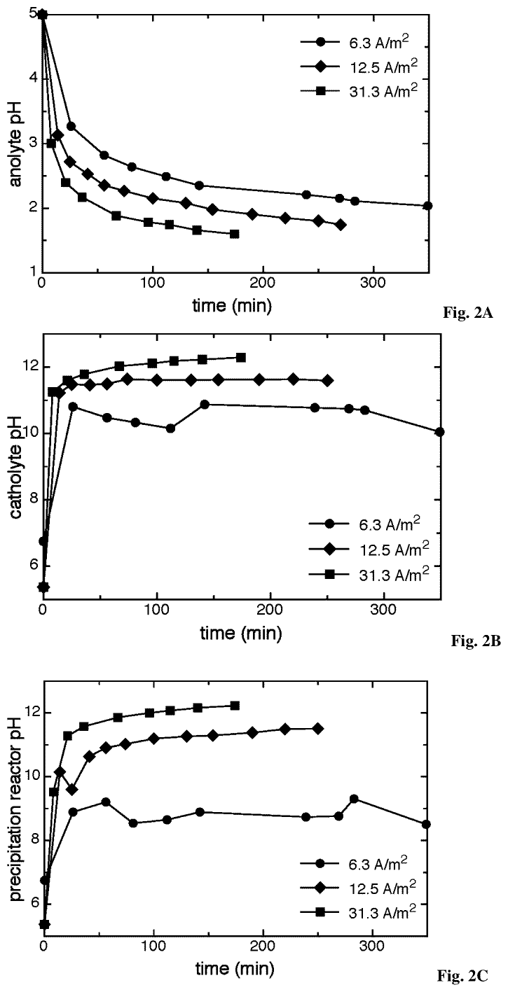

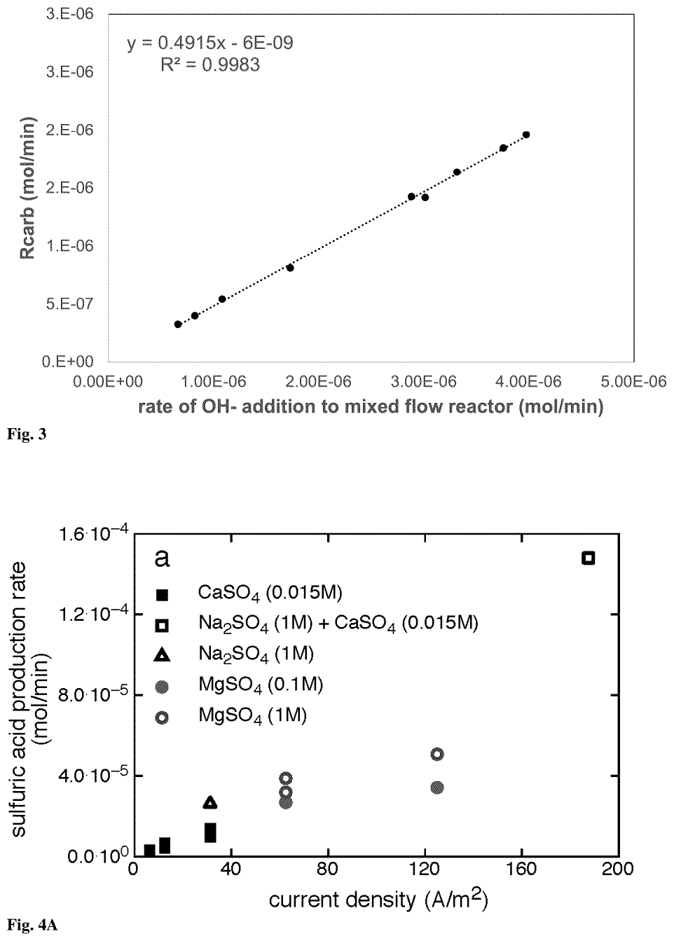

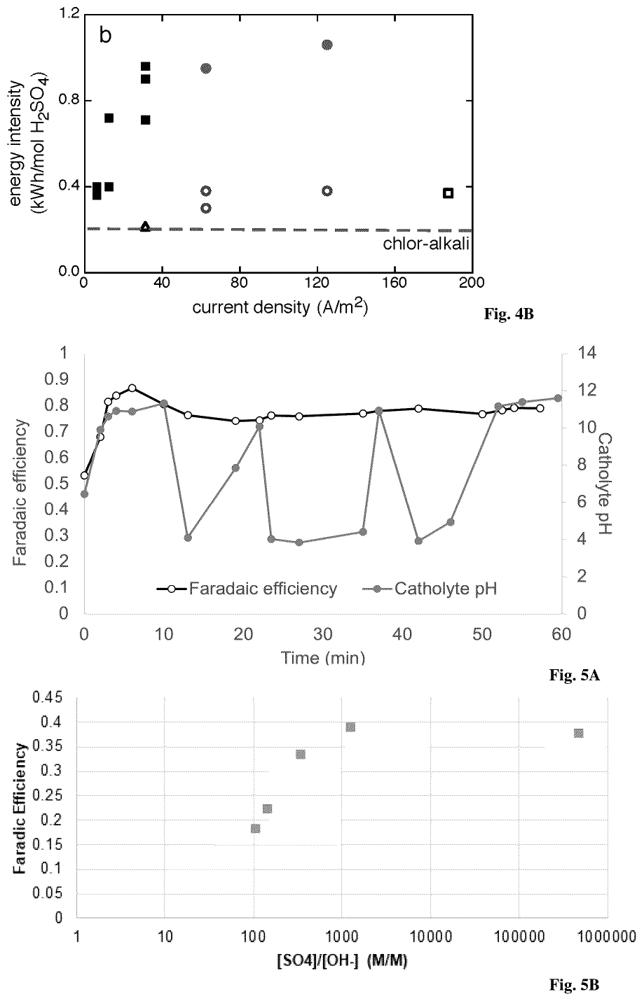

In an aspect we describe a continuous flow process for sulfuric acid production that permanently sequesters atmospheric air-derived CO₂ as mineral carbonate through the replacement of calcium or magnesium sulfate by calcium or magnesium carbonate. FIG. 1 is a flow chart illustrating an embodiment of the invention wherein solid calcium sulfate is introduced to a mineral precipitation reactor where it is converted to calcium carbonate by reaction with carbon dioxide from air and alkalinity produced in a two-chamber water electrolyzer. Effluent from the precipitation reactor is recirculated through the cathode chamber of the water electrolyzer, where sulfate liberated in reaction 1 crosses an anion exchange membrane to gradually accumulate sulfuric acid in a recirculating anolyte solution. During operation of the calcium-containing system, sulfuric acid and calcium carbonate are produced by reacting a calcium sulfate source with electrochemically produced hydroxide contacted with carbon dioxide derived from atmospheric air, although more concentrated sources of carbon dioxide can also be used. Experiments were performed over a range of current densities (6.3-31.3 A/m²) to investigate process efficiency under different kinetic regimes, and the rate of acid and base production is shown in FIG. 2A-C. At higher currents, the supply of CO₂ was rate-limiting, causing the catholyte solution to evolve towards high pH values, while at the lowest current, the production of base at the cathode limits the rate of mineral carbonation, and the catholyte chamber evolves towards a low steady state pH of 8-9, allowing for controlled calcium carbonate precipitation as aragonite. The carbonation rates observed in the lowest current experiment are shown in FIG. 3, which shows that the carbonation rate is approximately half the rate of base production at the cathode, because two equivalents of alkalinity are consumed per mole of CO₂ mineralized to CaCO₃. The rates and energy intensities of acid production are summarized in FIG. 4A-B for the process embodiment detailed in FIG. 1 for a series of different catholyte feedstock compositions including calcium sulfate, magnesium sulfate, and sodium sulfate and mixtures thereof in different concentrations. FIG. 5A shows that the Faradaic efficiency for the embodiment illustrated in FIG. 1 is high and the resulting energy intensity of acid production was low (0.2 kWh/mol H₂SO₄ in this experiment), demonstrating the high efficiency of this process compared to other industrial electrochemical processes. FIG. 5B explains the efficiency of this process by showing that maintaining a low pH in the catholyte significantly enhances process efficiency relative to typical electrochemical acid/base production by reducing OH⁻ migration across the anion exchange membrane relative to SO₄⁻. The invention enables efficient sulfuric acid production in a simple, two-chamber electrochemical cell (<0.4 kWh/mol H₂SO₄, with greater than about 80% Faradaic efficiency).

Materials and Methods

Reactor Design and Operation

A continuous flow reactor system was developed that couples sulfuric acid production to mineral carbon sequestration using gypsum as the source of calcium and sulfate. A flow diagram of the system constructed for the tests described here is illustrated in FIG. 1. Briefly, a membrane separated electrochemical cell is connected to a mixed flow reactor, where gypsum is converted to calcium carbonate (reaction 2). Effluent from the mixed flow reactor is recirculated into the cathode chamber to supply sulfate anion, which crosses the anion exchange membrane to the anode chamber where sulfuric acid is generated. The hydroxide solution produced in the cathode chamber is returned to the mixed flow reactor, where it reacts with CO₂ that is introduced by bubbling atmospheric air (reaction 3).

The electrochemical cell used in these tests consists of a platinized titanium anode and cathode separated by FuMA-Tech Fumasep FAS-PET-130 anion exchange membrane (AEM), connected to a potentiostat operated at a constant current, which are all readily available materials. The eluent of the mixed flow reactor is passed through a 0.45 um filter to remove suspended solids and then pumped into the cathode chamber of the electrochemical cell, where alkalinity increases by the hydrolysis reaction on the cathode: H₂O+e⁻→OH⁻+½ H₂(g). The more basic effluent from the cathode chamber is returned into the mixed flow reactor to supply alkalinity for calcium carbonate precipitation via reaction 1, which lowers the solution pH as alkalinity is consumed. On the anode side of the system, aqueous sulfuric acid was recirculated at a constant rate through the anode chamber to allow for the gradual accumulation of sulfuric acid using pure water as a starting solution, where protons and oxygen are generated by hydrolysis at the anode. Sulfate ions migrate from the catholyte via the AEM to balance charge, and sulfuric acid is recovered as the anolyte.

To initiate the process, the cathode chamber (50 mL) and mixed flow reactor (50 mL) were first filled with aqueous solution pre-equilibrated with gypsum and atmospheric CO₂, and then 3.0 g of powdered calcium sulfate dihydrate (gypsum) was added to the mixed flow reactor. The gypsum powder was prepared by crushing and milling selenite gypsum and sifting to recovery the <180 um size fraction (Ward's scientific). The initial mass of gypsum used was chosen such that the process rates are independent of the gypsum mass, as gypsum rapidly obtains chemical equilibrium with the aqueous solution. The pre-equilibrated aqueous solution was prepared by mixing doubly deionized water with 5.0 g of powdered gypsum and bubbling the solution with air for 30 minutes. The equilibrated solution was then vacuum filtered through at 0.2 μm PTFE membrane (Millipore) before filling the mixed flow reactor and the cathode chamber. The anode chamber (also 50 mL) is initially filled with doubly-deionized water and connected to a recirculating reservoir with an additional volume of 50 mL, such that the anode and cathode sides of the system both have a total volume of 100 mL of aqueous solution.

To begin an experiment, the potentiostat was powered on at the selected current, and flow was initiated on the cathode and anode sides of the system using two pumps operated at different flow rates: anolyte solution was rapidly recirculated to reduce charge polarization, while the catholyte flow rate of ˜3-5 mL/min was set to allow for an approximately 10-15 minute fluid residence time in the mixed flow reactor. The mixed flow reactor was sparged continuously with atmospheric air using a stainless-steel disseminator, which creates small bubbles that facilitate CO₂ dissolution into the aqueous solution. The rate of air sparging was held constant at 0.3 L air/min using a mass flow meter to ensure a constant CO₂ supply. The reactor is constantly mixed using a magnetic stir bar.

Experiments were performed at three current densities (6.3, 12.5, and 31.3 A/m²) corresponding to three different currents (I=0.01 A, 0.02 A, and 0.05 A) to investigate conditions under which the system is kinetically limited by the rate of electrochemical base production (0.01 A), to a condition where base production outpaces alkalinity consumption by gypsum conversion to calcite (0.02 A, 0.05 A). The time evolution of pH and sulfate concentration were monitored throughout the experiment at three sampling ports (SPs) labeled in FIG. 1: the anolyte vessel (SP1), the cathode chamber effluent (SP2), and the effluent of the mixed flow reactor (SP3). Measurements were obtained using a pH electrode. The anolyte was sub-sampled over time for pH and sulfate concentration.

Solid and Solution Phase Analysis

Subsampled aliquots of aqueous solution were routinely analyzed for pH measured using a SI Analytics BlueLine pH probe calibrated at pH 1.68, 4, and 10. Solid aliquots were sampled, separated by vacuum filtration, and air dried at ambient temperature for mineralogical characterization.

Electrochemistry Efficiency Tests Relevant to Other Embodiments

Efficiency of the electrochemical cell relevant to various embodiments of the process was determined by generating sulfuric acid in batch mode in solutions of sodium, calcium, and magnesium sulfate and mixtures thereof, while intermittently dosing the catholyte with sulfuric acid solution to neutralize the pH (e.g., to remove OH⁻ by H⁺+OH→H₂O), thereby mimicking the full process performance. Faradaic efficiency was also calculated for each full-process experiment based on the rate of acid generation in the anolyte solution for a given current.

Kinetic Modeling

The dynamic evolution of pH in the mixed flow reactor can be completely described by contributions from three processes: OH⁻ production in the cathode (f_{c}, mol OH⁻/min), OH⁻ loss by migration through the AEM (f_{AEM}), and OH⁻ consumption by mineral carbonation. Net OH⁻ produced at the cathode (f_{net,c}=f_{c}−f_{AEM}) enters the mixed flow reactor, and a mass balance on pH in the reactor can be written,

d[OH⁻]_{MFR}/dt=fᵢₙ−fₒᵤₜ−2R_{carb},

where fᵢₙ and fₒᵤₜ represent the flow of OH⁻ into the mixed flow reactor by introducing catholyte and by removing reactor effluent, respectively, and R_{carb} is the rate of calcium carbonate precipitation (mol CaCO₃/min). For a volumetric flow rate through the mixed flow reactor v_{c} (mL/min), we determine the flux of OH⁻ through the mixed flow reactors at time t based on the pH of catholyte (pH_{c}; fluid sampled from SP2), fᵢₙ(t)=v_{c}10^{-(14-pHc(t))}. Similarly, the flux of OH⁻ out of the MFR depends on the pH of the fluid effluent (pH_{eff}; fluid sampled from SP2), fₒᵤₜ(t)=v_{c}10^{-(14-pHeff(t))}. The rate of mineral carbonation in the mixed flow reactor is determined as a function of time by rearranging the equation above:

R_{carb}=−0.5[(10^{-(14-pHeff(t2))}−10^{-(14-pHeff(t1))})/(t₂−t₁)−v_{c}10^{-(14-pHc(t))}+v_{c}10^{-(14-pHeff(t))}].

Results and Discussion

Evolution of fluid chemistry and process kinetics. Time resolved measurements of fluid pH in the recirculating anolyte (SP1), catholyte effluent (SP2), and mixed flow reactor effluent (SP3) are given in FIGS. 2A-C for experiments performed at 0.01 A, 0.02 A, and 0.05 A current in the electrochemical cell. The evolution of pH in the catholyte and mixed flow reactor depend on the competing rates of base production at the cathode, which increases pH, counteracted by base consumption by carbonate mineral precipitation. Higher rates of base production were obtained at higher potentiostat currents, such that the highest current experiments constantly evolved towards a higher pH in the mixed flow reactor throughout the course of each experiment (2-4 hour duration).

The process kinetics were evaluated by applying mass balance expressions to determine the rates of acid and base production as well as the rate of gypsum carbonation (R_{carb}). The calculated rate of carbonate mineral precipitation R_{carb}=4.2±0.6 and 4.3±1.2×10⁻⁶ (mol/min) in the 0.02 and 0.05 A experiments, respectively. Invariant rate with solution pH or base production rate suggests that the process is rate-limited by the rate of CO₂ hydrolysis. To confirm this hypothesis, we calculated the mass flux of CO₂ being introduced to the mixed flow reactor by air bubbling. All experiments were performed using a constant volumetric flow rate of 0.29 L/min, which equates to 5.04×10⁻⁶ mol CO₂/min assuming a CO₂ concentration of 380 ppmv. The measured carbonate precipitation rates for the higher current experiments are similar to this CO₂ flux, which supports the conclusion that CO₂ supply is rate-limiting.

In contrast, for the experiment run at the lowest current (0.01 A), the pH on the cathode side evolved towards a low value that fluctuated from pH˜8 to 9.5 (FIGS. 2A-C). These fluctuations can be explained by the observed linear dependence of the carbonation rate on the pH in the mixed flow reactor (FIG. 3). The slope of 0.5 is consistent with the stoichiometry of the carbonation reaction (reaction 2), where 2 moles of OH⁻ are consumed per mole of carbonate precipitated, indicating that the process kinetics are completely controlled by the rate of base production in this experiment. The process in this case is the most efficient electrochemically, because minimal OH⁻ is lost across the AEM, but the overall measured rate of carbonation was ˜4 times slower in this case compared to the higher current experiments. To optimize the overall process efficiency, both the electrochemical efficiency and the rates of carbonation must be considered. Maximum efficiency will be achieved when the CO₂ hydrolysis flux is equivalent to the rate of base supply, such that the rate of carbonate precipitation is maximized while maintaining a relatively low steady-state pH in the cathode chamber.

Solid products. The mineralogy of the solid product was determined for an experiment run for an extended duration (10 hours total) at a constant 0.02 A current. The product was demonstrated to contain appreciable calcium carbonate mineral by a fizz test with 10% nitric acid. Fourier Transform Infrared Spectroscopy (FTIR) was used to identify the carbonate product as aragonite, which is a polymorph of CaCO₃.

Electrochemistry rates & efficiency. The energy consumption required for acid and base generation in the electrochemical cell was measured for the system configuration during individual experiments as well as in batch mode. During the continuous flow process experiments, both the time-averaged rate of acid production and the energy consumption per mole of H₂SO₄ scaled linearly with current (FIG. 4A-B) in solutions of all compositions. Observed values of Faradaic efficiency varied from 48-58% in these experiments and did not vary systematically with the applied current. Higher Faradaic efficiencies were observed in concentrations with higher sulfate concentration in the catholyte (FIG. 4B), due to reduced Voltages as well as lower Faradaic losses from maintaining a higher ratio of sulfate to hydroxide ions in the catholyte solution.

In batch mode with 1M Na₂SO₄ initial catholyte solution, the Faraday efficiency increases at the beginning of the experiment as the ionic strength in the anolyte goes from zero (DI water is used as the initial solution) to some threshold value (FIG. 5A). The Faraday efficiency of acid generation was high without significant optimization of the electrochemical cell with an average value of 76.8+−0.8% and is independent of the SO₄²⁻/OH⁻ for a wide range of ratios in high sulfate concentrations. To explore the influence of competing OH⁻ transport across the AEM, we measured the dependence of the Faradaic efficiency on the ratio of aqueous [SO₄²⁻]/[OH⁻] and found that the efficiency decreases for [SO₄²⁻]/[OH⁻] ratios less than ˜1000 (FIG. 5B). For a system initiated with sulfate and calcium concentrations at stoichiometric saturation with gypsum (0.015 M SO₄²⁻ based on calculations using PHREEQc geochemical speciation software), this ratio is equivalent to a pH<=9. Thus, if the mixed flow reactor conditions are held at pH<9 by adjusting the rate of base production at the cathode, the process can be maintained at maximum electrochemical efficiency for long durations. Alternatively, additional sulfate can be supplied to the catholyte side of the system (e.g. as sodium sulfate) to maintain a high sulfate concentration relative to hydroxide in the catholyte in more concentrated solutions.

The energy consumption data combined with the rate of acid production in the batch mode can be used to estimate the energy required per tonne of sulfuric acid produced. We find that the energy intensity varies within the range of 0.13-0.4 kWh/mol H₂SO₄, which is a very low cost compared to typical electrochemical acid/base production and is independent of current density at sufficiently high sulfate concentrations. Energy efficiencies of sulfuric acid and base production by the process described here are on par with the industry-leading chlor-alkali process. The process can achieve similar efficiencies to chlor-alkali by minimizing Faradaic losses. Faradaic losses are avoided in this system by maintaining a high sulfate to hydroxide ratio in the catholyte (>10), which is accomplished in this process by circulating separate solutions through the anode and cathode chambers. At these efficiencies, the unit economics of sulfuric acid production by electrochemical processes becomes economically viable.

Applications.

Production of Carbon Negative Sulfuric Acid, e.g., for Critical Element Extraction from Silicate Materials.

Sulfuric acid leaching and weathering of silicate minerals can neutralize the acidity while at the same time liberating valuable elements. For example, production of lithium carbonates from lithium-bearing claystones (e.g. hectorite, a type of smectite clay mineral) is being explored at large deposits in Nevada. Lithium is commonly extracted from ores using low concentration sulfuric acid leaching (cf. Meshram et al., 2014). Lithium carbonate can be recovered from claystone by reaction with sulfuric acid, for example:

3H₂SO₄+Na_{0.3}(Mg_{2.7}Li_{0.3})Si₄O₁₀(OH)₂(hectorite)+0.3NaHCO₃→0.15Li₂CO₃+4SiO₂+4.15H₂O+2.7MgSO₄+0.3Na₂SO₄+0.15CO₂

Completion of the weathering process through protonation and hydrolysis of silicate mineral ores to completely neutralize acidity can be slower than the extraction step. For example, one study showed that smectite minerals can consume and neutralize approximately 1 kg H₂SO₄ per ton of clay mineral per day at 25° C. (Bibi et al., 2014). Some silicate minerals such as serpentine and olivine neutralize acidity much more quickly (McCutcheon et al., 2015; Hamilton et al., 2020).

In an embodiment (FIG. 6), a process is provided for sulfuric acid leaching of lithium claystone, with return of the magnesium sulfate-containing leachate post-lithium extraction to the mixed flow reactor, recycling the sulfuric acid and precipitating the magnesium sulfate as magnesium carbonate.

Recycling of Phosphogypsum for Carbon Negative Phosphate Fertilizer Production.

The main industrial process that consumes sulfuric acid is the production of phosphoric acid for agricultural fertilizer (King & Moats, 2013), which yields gypsum as a byproduct,

Ca₅F(PO₄)₃(apatite)+5H₂SO₄+10H₂O→3H₃PO₄+5CaSO₅·2H₂O(gypsum)+HF.

Other uses of sulfuric acid include mining and extraction of valuable metals such as nickel, copper, and lithium. These PG piles have longstanding environmental and ecological impacts along the global coasts including Florida, Morocco, etc., wherever phosphorus fertilizer is produced. Phosphogypsum deposits also contain elevated concentrations of radionuclides and therefore have limited industrial uses in the United States. However, many of the trace element constituents of PG, including rare earth elements (REEs), uranium, and other metals, have significant value and could be valorized following selective recovery from PG (Mattila et al., 2015; Tayibi et al., 2009).

In another aspect (FIG. 7), a process is provided for generation of phosphoric acid from rock phosphorus with calcite as the solid product instead of phosphogypsum, for example:

Ca₅F(PO₄)₃(fluorapatite)+5CO₂(g)+5H₂O(l)→5CaCO₃(calcite)+3H₃PO₄+HF

The method includes the cyclic steps of electrochemical production of sulfuric acid at the anode and calcium hydroxide aqueous solution at the cathode. The hydroxide solution is reacted with carbon dioxide to produce solid calcium carbonate. In this aspect, the sulfuric acid anolyte is recovered, concentrated as necessary to 93-98% H₂SO₄ and reacted with rock phosphorus to produce phosphoric acid, calcium sulfate, and HF (as in reaction 2). The product calcium sulfate is returned to the process to produce calcium carbonate (as calcite, aragonite, and/or vaterite) and sulfate solution. The sulfate solution is returned to the electrochemical cell along with water to continue the cycle (FIG. 7).

Further flows charts of steps of embodiments of the invention are shown in FIGS. 8-11.

### REFERENCES CITED

Azdarpour, A., Asadullah, M., Junin, R., Manan, M., Hamidi, H. and Mohammadian, E. (2014) Direct carbonation of red gypsum to produce solid carbonates. Fuel Processing Technology 126, 429-434.
Bibi, I., Singh, B. and Silvester, E. (2014) Dissolution kinetics of soil clays in sulfuric acid solutions: Ionic strength and temperature effects. Applied geochemistry 51, 170-183.
Blättler, C. L. and Higgins, J. A. (2017) Testing Urey's carbonate-silicate cycle using the calcium isotopic composition of sedimentary carbonates. Earth and Planetary Science Letters 479, 241-251.
Cárdenas-Escudero, C., Morales-Flórez, V., Pérez-López, R., Santos, A. and Esquivias, L. (2011) Procedure to use phosphogypsum industrial waste for mineral CO₂ sequestration. Journal of hazardous materials 196, 431-435.
Crangle, R. D. (2020) Gypsum Mineral Commodity Summary, in: Survey, U.S.G. (Ed.).
Esquivias, L., Morales-Flórez, V. and Santos, A. (2018) Carbon dioxide sequestration by phosphogypsum based procedure, Carbon Dioxide Sequestration in Cementitious Construction Materials. Elsevier, pp. 199-223.
Fernández-Díaz, L., Pina, C. M., Astilleros, J. M. and Sánchez-Pastor, N. (2009) The carbonatation of gypsum: Pathways and pseudomorph formation. American Mineralogist 94, 1223-1234.
Hamilton, J. L., Wilson, S. A., Morgan, B., Harrison, A. L., Turvey, C. C., Paterson, D. J., Dipple, G. M., Southam, G. (2020) Accelerating mineral carbonation in ultramafic mine tailings via direct CO₂ reaction and heap leaching with potential for base metal enrichment and recovery. Economic Geology, 115, 303-323.
IPCC (2018) Global warming of 1.5 C, An IPCC Special Report on the impacts of global warming of 1.5 C above pre-industrial levels and related global greenhouse gas emission pathways, in the context of strengthening the global response to the threat of climate change, sustainable development, and efforts to eradicate poverty.
King, M., Moats, M. and Davenport, W. G. (2013) Sulfuric acid manufacture: analysis, control and optimization. Newnes.
Lal, R. (2008) Carbon sequestration. Philosophical Transactions of the Royal Society B: Biological Sciences 363, 815-830.
Mac Dowell, N., Fennell, P. S., Shah, N. and Maitland, G. C. (2017) The role of CO 2 capture and utilization in mitigating climate change. Nature Climate Change 7, 243-249.
Mattila, H.-P. and Zevenhoven, R. (2015) Mineral carbonation of phosphogypsum waste for production of useful carbonate and sulfate salts. Frontiers in Energy Research 3, 48.
McCutcheon, J., Dipple, G. M., Wilson, S. A. and Southam, G. (2015) Production of magnesium-rich solutions by acid leaching of chrysotile: A precursor to field-scale deployment of microbially enabled carbonate mineral precipitation. Chemical Geology 413, 119-131.
Meshram, P., Pandey, B. and Mankhand, T. (2014) Extraction of lithium from primary and secondary sources by pre-treatment, leaching and separation: A comprehensive review. Hydrometallurgy 150, 192-208.
Monat, L., Chaudhury, S. and Nir, O. (2020) Enhancing the sustainability of phosphogypsum recycling by integrating electrodialysis with bipolar membranes. ACS Sustainable Chemistry & Engineering 8, 2490-2497.
Osman, A. I., Hefny, M., Abdel Maksoud, M., Elgarahy, A. M. and Rooney, D. W. (2021) Recent advances in carbon capture storage and utilisation technologies: a review. Environmental Chemistry Letters 19, 797-849.
Paidar, M., Fateev, V. and Bouzek, K. (2016) Membrane electrolysis-History, current status and perspective. Electrochimica acta 209, 737-756.
Paleologou, M., Thibault, A., Wong, P.-Y., Thompson, R. and Berry, R. (1997) Enhancement of the current efficiency for sodium hydroxide production from sodium sulphate in a two-compartment bipolar membrane electrodialysis system. Separation and purification technology 11, 159-171.
Rahmani, O. (2018) CO₂ sequestration by indirect mineral carbonation of industrial waste red gypsum. Journal of CO₂ Utilization 27, 374-380.
Rahmani, O., Junin, R., Tyrer, M. and Mohsin, R. (2014) Mineral carbonation of red gypsum for CO₂ sequestration. Energy & fuels 28, 5953-5958.
Ruiz-Agudo, E., Putnis, C. V., Hövelmann, J., Álvarez-Lloret, P., Ibañez-Velasco, A. and Putnis, A. (2015) Experimental study of the replacement of calcite by calcium sulphates. Geochimica et Cosmochimica Acta 156, 75-93.
Sullivan, I., Goryachev, A., Digdaya, I. A., Li, X., Atwater, H. A., Vermaas, D. A. and Xiang, C. (2021) Coupling electrochemical CO₂ conversion with CO₂ capture. Nature Catalysis 4, 952-958.
Talabi, O. O., Dorfi, A. E., O'Neil, G. D. and Esposito, D. V. (2017) Membraneless electrolyzers for the simultaneous production of acid and base. Chemical Communications 53, 8006-8009.
Tayibi, H., Choura, M., López, F. A., Alguacil, F. J. and López-Delgado, A. (2009) Environmental impact and management of phosphogypsum. Journal of environmental management 90, 2377-2386.
Wigley, T. (1973) Chemical evolution of the system calcite-gypsum-water. Canadian Journal of Earth Sciences 10, 306-315.
Yu, L., Daniels, L. M., Mulders, J. J., Saldi, G. D., Harrison, A. L., Liu, L. and Oelkers, E. H. (2019) An experimental study of gypsum dissolution coupled to CaCO3 precipitation and its application to carbon storage. Chemical Geology 525, 447-461.
Zeman, F. (2007) Energy and material balance of CO₂ capture from ambient air. Environmental science & technology 41, 7558-7563.

1. A system that couples sulfuric acid production to mineral carbon sequestration, the system comprising:
an electrolyzer stack of one or more electrochemical cells comprising:
an anode within an anode chamber containing an anolyte,
a cathode within a cathode chamber containing a catholyte, and
an anion exchange membrane separating the anode and cathode chambers;
a mineralized carbonate production reactor configured to receive a hydroxide solution from the cathode chamber, to generate mineralized carbonate from a sulfate feedstock and CO₂, and to return some or all of the reactor solution to the cathode chamber; and
a sulfuric acid recovery module configured to receive sulfuric acid from the anode chamber.

2. The system of claim 1, wherein the system is configured as a continuous flow system.

3. The system of claim 1, wherein the mineralized carbonate production reactor is operably connected to a source of sulfate.

4. The system of claim 3, wherein the source of sulfate comprises solid calcium sulfate.

5. The system of claim 1, where the mineralized carbonate production reactor is operably connected to a source of CO₂.

6. The system of claim 5, wherein the source of CO₂ comprises air.

7. The system of claim 1, wherein the mineralized carbonate production reaction is configured to convert a gypsum to calcium carbonate according to the reaction:
CaSO₄·2H₂O(gypsum)+2OH⁻+CO₂(g)→CaCO₃(s)+SO₄²⁻(aq)+3H₂O(l).

8. The system of claim 1, wherein the anion exchange member is configured so that sulfate anion crosses the anion exchange membrane to the anode chamber where sulfuric acid is generated.

9. The system of claim 8, wherein the system is configured to maintain a relatively low concentration of base (OH⁻) in the catholyte relative to the concentration of acid (H⁺) in the anolyte by recirculating fluid from the mineralized carbonate production reactor through the cathode chamber.

10. The system of claim 9, wherein the system is configured to generate an acid concentration in the anolyte that is higher than the base concentration in the catholyte even though protons and hydroxides are produced at the same rate in the electrochemical cell.

11. The system of claim 1, wherein on the anode side of the system, aqueous sulfuric acid is recirculated at a constant rate through the anode chamber to allow for accumulation of sulfuric acid.

12. The system of claim 1, wherein the system is configured for hydrometallurgical extraction or recovery using sulfuric acid obtained from the sulfuric acid recovery module.

13. The system of claim 12, wherein the hydrometallurgical extraction or recovery comprises sulfuric acid leaching of lithium claystone or other magnesium silicate.

14. The system of claim 13, wherein the system is further configured to return the leachate post-lithium extraction to the mineralized carbonate production reactor to recycle the sulfate and produce mineralized carbonate therefrom.

15. The system of claim 1, wherein the system is configured for phosphoric acid production with mineral carbon sequestration.

16. The system of claim 15, wherein the system is configured for generation of phosphoric acid from rock phosphorus with calcium carbonate as the solid product as described by the reaction:
Ca₅F(PO₄)₃(fluorapatite)+5CO₂(g)+5H₂O(l)→5CaCO₃(calcite or aragonite)+3H₃PO₄+HF.

17. The system of claim 1, wherein the system is configured to include cyclic steps of electrochemical production of sulfuric acid at the anode and calcium hydroxide aqueous solution at the cathode, wherein the hydroxide solution is reacted with carbon dioxide to produce solid calcium carbonate.

18. The system of claim 17, wherein the system is configured to include cyclic steps of electrochemical production of sulfuric acid at the anode and calcium hydroxide aqueous solution at the cathode, wherein the hydroxide solution is reacted with carbon dioxide and calcium ion to produce solid calcium carbonate, wherein the sulfuric acid anolyte is recovered, concentrated as necessary to >70% H₂SO₄ and reacted with rock phosphorus to produce phosphoric acid, calcium sulfate, and HF, wherein the product calcium sulfate is returned to the process to produce calcium carbonate and sulfate solution, wherein the sulfate solution is returned to the electrochemical cell along with water to continue the cycle.

19. The system of claim 1, further configured to sequester carbon dioxide as calcium carbonate and produce sulfuric acid by reacting calcium sulfate solids with electrochemically produced hydroxide solution contacted with carbon dioxide directly from air or from a more concentrated source.

20. The system of claim 1, further configured to include one or more of a sulfuric acid concentration step, a step to recover hydrogen or energy from produced hydrogen using a fuel cell, a phosphoric acid production step, and valuable co-product recovery steps.
